(19) United States
(12) Patent Application Publication
(10) Pub. No.: US 2021/0082082 A1
(43) Pub. Date: Mar. 18, 2021

(54) DATA PROCESSING METHOD AND PROCESSING CIRCUIT

(71) Applicant: SZ DJI TECHNOLOGY CO., LTD., Shenzhen (CN)

(72) Inventors: Yao ZHAO, Shenzhen (CN); Qian GU, Shenzhen (CN); Feng HAN, Shenzhen (CN)

(21) Appl. No.: 17/105,401

(22) Filed: Nov. 25, 2020

Related U.S. Application Data
(63) Continuation of application No. PCT/CN2018/089404, filed on May 31, 2018.

(51) Int. Cl. G06T 1/60; G06T 1/00

(52) U.S. Cl. CPC G06T 1/60; G06T 1/0007

(57) ABSTRACT

A data processing method and a processing circuit are provided. The method includes obtaining a first input data and a data length of the first input data; obtaining a first value according to a byte offset and the data length of the first input data, the first value including N bits, each bit of the first value is either a first identifier or a second identifier, and each bit corresponding to one storage queue; obtaining a second input data according to the byte offset and the first input data, each sub-data corresponding to one bit in the first value; selecting the sub-data corresponding to a bit having the first identifier, and storing the selected sub-data in the storage queue corresponding to the bit having the first identifier; and when a data output condition is satisfied, outputting the sub-data stored in the storage queue.

### CROSS-REFERENCE TO RELATED APPLICATION

This application is a continuation of International Application No. PCT/CN2018/089404, filed on May 31, 2018, the entire content of which is incorporated herein by reference.

### TECHNICAL FIELD

The present disclosure generally relates to the field of image processing technology and, more particularly, relates to a data processing method and a processing circuit.

### BACKGROUND

An image processing process often includes an outside-padding operation for an image. For example, FIG. 1A illustrates a convolution example without padding, where the size of the convolution kernel is 3*3, and the stride is 1. Referring to FIG. 1A, the size of an input feature image (also referred as an input feature map) is 5*5, and the size of an output feature image (also referred as an output feature map) becomes 3*3 without padding. To obtain the output feature map with a same size as the input feature map, the outside-padding operation is performed on the input feature map. For example, a zero-padding operation is performed on the edges of the input feature map. FIG. 1B illustrates a schematic diagram of padding 1 zero for each edge of the input feature map, also known as half-padding. FIG. 1C illustrates a schematic diagram of padding 2 zeros for each edge of the input feature map, also known as full-padding. FIG. 1D illustrates a schematic diagram of padding an arbitrary number of zeros for each edge of the input feature map, also known as arbitrary-padding.

In the image processing process, if a central processing unit (CPU) is used to accomplish the above-mentioned outside-padding operation, the processing burden of the CPU greatly increases, and the processing efficiency is substantially low. The disclosed data processing method and processing circuit are directed to solve one or more problems set forth above and other problems.

### SUMMARY

One aspect of the present disclosure provides a data processing method. The method includes: obtaining a first input data and a data length of the first input data; obtaining a first value according to a byte offset and the data length of the first input data, wherein the first value includes N bits, a value of each bit of the first value is one of a first identifier and a second identifier, and each bit corresponds to one storage queue; obtaining a second input data according to the byte offset and the first input data, wherein each sub-data included in the second input data corresponds to one bit in the first value; selecting the sub-data corresponding to a bit whose value is the first identifier from the second input data, and storing the selected sub-data in the storage queue corresponding to the bit whose value is the first identifier; and when a data output condition is satisfied, outputting the sub-data stored in the storage queue.

Another aspect of the present disclosure provides a processing circuit. The processing circuit includes a selection sub-circuit configured to obtain a first value according to a byte offset and a data length of a first input data, and a first shifting sub-circuit configured to obtain a second input data according to the byte offset and the first input data. The first value includes N bits, a value of each bit of the first value is one of a first identifier and a second identifier, and each bit corresponds to one storage queue. Each sub-data included in the second input data corresponds to one bit in the first value. The processing circuit also includes at least N storage queues, configured to store the sub-data included in the second input data and corresponding to a bit whose value is the first identifier into a storage queue corresponding to the bit whose value is the first identifier. When a data output condition is satisfied, the sub-data stored in the at least N storage queues is outputted.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIGS. 1A-1D illustrate schematic diagrams of performing an outside-padding operation on input feature maps;

FIG. 2 illustrates a schematic flowchart of an exemplary data processing method consistent with disclosed embodiments of the present disclosure;

FIG. 3 illustrates a schematic diagram of an application scenario of an outside-padding operation consistent with disclosed embodiments of the present disclosure;

FIG. 4 illustrates a schematic flowchart of another exemplary data processing method consistent with disclosed embodiments of the present disclosure;

FIGS. 5A-5B illustrate schematic diagrams of performing an inside-padding operation on input feature maps consistent with disclosed embodiments of the present disclosure; and

FIGS. 6A-6C illustrate schematic diagrams of an application scenario of an inside-padding operation consistent with disclosed embodiments of the present disclosure.

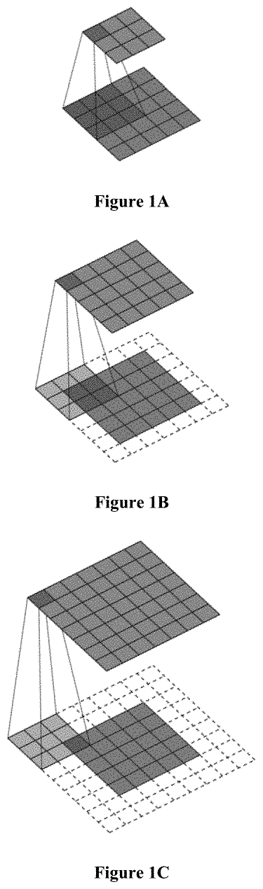

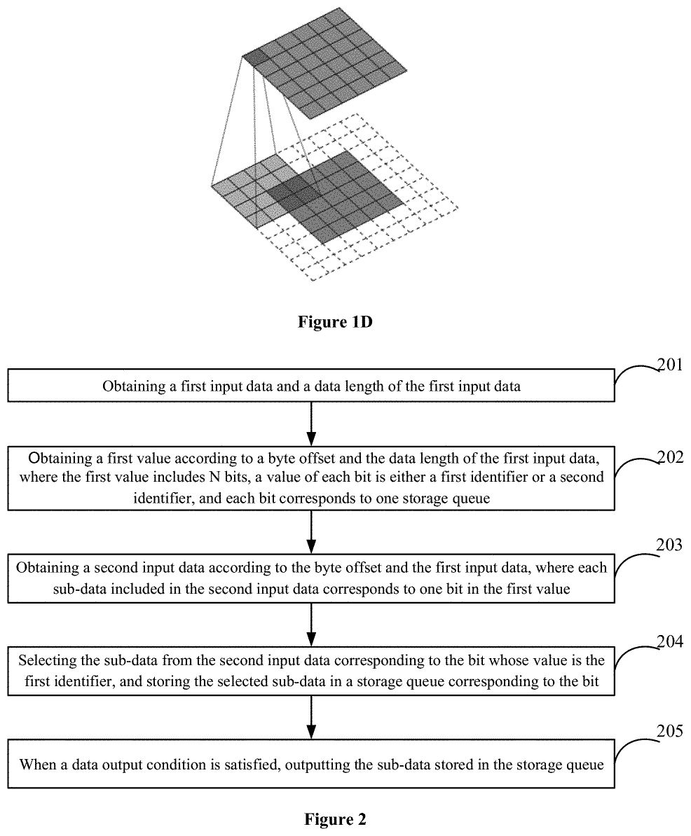

### DETAILED DESCRIPTION OF THE DISCLOSURE

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

Similar reference numbers and letters represent similar terms in the following Figures, such that once an item is defined in one Figure, it does not need to be further discussed in subsequent Figures.

The terms used in the present disclosure are only for purpose of describing specific embodiments, rather than limiting the present disclosure. The singular form of “a”, and “the” used in the present disclosure and claims are intended to include plural forms, unless the context clearly indicates other meanings. It should be understood that the term “and/or” used herein refers to any or all possible combinations of one or more associated listed items.

Although the terms “first”, “second”, “third”, etc. may be used in the present disclosure to describe various information, the information should not be limited to these terms. These terms are used to distinguish the same type of information from each other. For example, without departing from the scope of the present disclosure, the first information may also be referred to as the second information, and similarly, the second information may also be referred to as the first information. Depending on the context, the word “if” may be interpreted as “when”, or “in response to”.

### Exemplary Embodiment 1

The present disclosure provides a data processing method. The data processing method may be configured to achieve the function of aligning output with input having variable length (e.g., an outside-padding operation such as padding zeros to the edges of an input feature map). FIG. 2 illustrates a schematic flow chart of the data processing method. The method may include following.

In step 201: obtaining a first input data and a data length of the first input data. The first input data may include but may not be limited to an image pixel value, and/or an outside-padding pixel value.

In step 202: obtaining a first value according to a byte offset and the data length of the first input data. The first value may include N bits, and a value of each bit may be either a first identifier (such as 1) or a second identifier (such as 0). Each bit may correspond to one storage queue. In other words, the first value may include N storage queues, and each bit may correspond to one storage queue.

In one embodiment, obtaining the first value according to the byte offset and the data length may include: converting the data length into a second value with N bits, where a value of each bit of the second value may be one of the first identifier and the second identifier (that is, either the first identifier or the second identifier); and offsetting the second value according to the byte offset to obtain the first value.

Further, converting the data length into the second value with N bits may include: based on the data length M (in other words, the data length is M), setting the last M bits of the second value as the first identifier, and setting the first N−M bits of the second value as the second identifier, where M may be less than or equal to N.

Further, offsetting the second value according to the byte offset to obtain the first value may include: determining a first offset number L1 according to the byte offset, and cyclically left-shifting L1 bits for each bit in the second value to obtain the first value. Moreover, the first offset number L1 may be the byte offset.

In step 203: obtaining a second input data according to the byte offset and the first input data. Each sub-data included in the second input data corresponds to one bit in the first value.

In one embodiment, obtaining the second input data according to the byte offset and the first input data may include but may not be limited to: determining a second offset number L2 according to the byte offset, and cyclically left-shifting L2 bits for each sub-data in the first input data to obtain the second input data. The second offset number may include a product of the byte offset and a specific value.

In the above embodiment, before obtaining the first value according to the byte offset and the data length, the byte offset may be read from an offset register. Before obtaining the second input data according to the byte offset and the first input data, the byte offset may be read from the offset register. The offset register may be configured to record the byte offset, and the byte offset recorded by the offset register may be less than or equal to N.

Further, after obtaining the second input data according to the byte offset and the first input data, the byte offset in the offset register may be added with the data length to obtain a new byte offset. Then, the obtained byte offset may be updated to the offset register.

In step 204: selecting the sub-data corresponding to the bit whose value is the first identifier from the second input data, and storing the selected sub-data in the storage queue corresponding to the bit.

In step 205: when a data output condition is satisfied, outputting the sub-data stored in the storage queue.

When detecting that every storage queue stores the sub-data (in other words, every storage queue is non-empty), it may be determined that the data output condition is satisfied, and then the sub-data stored in the storage queue may be outputted.

Outputting the sub-data stored in the storage queue may include but may not be limited to: reading sub-data from each storage queue of entire storage queues, and outputting the read sub-data.

In the foregoing embodiment, the storage queue may be an asymmetric storage queue. The storage queue may include but may not be limited to a first-input-first-output (FIFO) queue.

Based on the above technical solutions, in the disclosed embodiments of the present disclosure, the outside-padding operation (such as the zero-padding operation performed on the edges of the input feature map) may be achieved by a processing circuit, and the CPU may not need to implement the outside-padding operation. Therefore, the burden of the CPU may be reduced, the outside-padding operation may be efficiently performed, and the processing efficiency may be improved.

### Exemplary Embodiment 2

The present disclosure provides a data processing method. The data processing method may be applied to a processing circuit to achieve the function of producing aligned output from input with a variable length (e.g., outside-padding operation, zero-padding operation performed on the edge of the input feature map) and to achieve an asymmetric storage queue structure with variable transmission length, and may have a strong scalability.

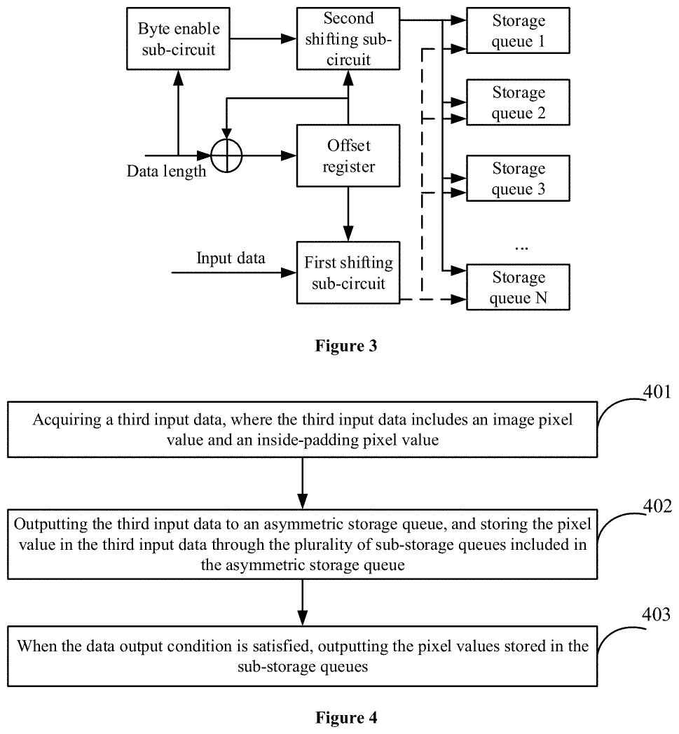

Referring to FIG. 3, the processing circuit may include a first shifting sub-circuit, a storage queue, a byte enable sub-circuit, a second shifting sub-circuit, and an offset register. Each storage queue may be an asymmetric storage queue, e.g., a FIFO queue. A quantity of storage queues may be N, and the output data may be aligned according to N bytes. In other words, the quantity of storage queues may be configured according to the number of bytes of the output data. Each storage queue may have a data bit width of 1 byte, and a depth greater than or equal to 2 (that is, each storage queue may store two or more data with bid width of 1 byte). For example, if the output data is aligned according to 16 bytes, the quantity of storage queues may be 16. If the output data is aligned according to 8 bytes, the quantity of storage queues may be 8. The quantity of the storage queues may not be limited by the present disclosure, and for illustrative purposes, N=16 may be used an example for description in the following.

Referring to FIG. 3, the offset register (ofst_reg) may be configured to record a byte offset of the current input data, and the byte offset may be added with the data length of the current input data to obtain a new byte offset. The new byte offset may be used as the byte offset of following/next input data. In other words, the new byte offset may replace the byte offset in the offset register. Moreover, the byte offset recorded by the offset register may be less than or equal to N. Once the byte offset overflows, the byte offset may be reversed.

As shown in FIG. 3, the byte enable sub-circuit (in other words, the byte enabling logic) may be configured to convert the data length into a second value having N bits, and the value of each bit of the second value may be one of the first identifier (e.g., 1) and the second identifier (e.g., 0). In one embodiment, if the data length is M, the last M bits of the second value may be configured as the first identifier, and the first N−M bits of the second value may be configured as the second identifier.

For example, when N=16 and M=1, the second value may be 0000000000000001. In addition, when N=16 and M=2, the second value may be 0000000000000011; when N=16 and M=3, the second value may be 0000000000000111, and so on. When N=16 and M=16, the second value may be 1111111111111111.

Referring to FIG. 3, the second shifting sub-circuit may be configured to read the byte offset from the offset register, and offset the second value according to the byte offset to obtain the first value. For example, a first offset number L1 (in other words, the byte offset) may be determined according to the byte offset, and each bit in the second value may be cyclically left-shifted L1 bits to obtain the first value. When left-shifting one bit of the second value, the left most bit (Nth bit) of the second value becomes the right most bit (first bit).

In one embodiment, if the second value is 0000000000000001 and the byte offset is 1, in other words, the first offset number L1 is 1, then each bit in 0000000000000001 may be cyclically left-shifted one bit to obtain the first value 0000000000000010. If the first offset number is 2, the first value may be 0000000000000100.

In another embodiment, if the second value is 0111111111111111 and the byte offset is 1, in other words, the first offset number is 1, then each bit in 0111111111111111 may be cyclically left-shifted 1 bit to obtain the first value 1111111111111110. If the first offset number is 2, the first value may be 1111111111111101.

After obtaining the first value, the second shifting sub-circuit may generate a signal for a write enable bus of the storage queue according to the first value, and the write enable bus may be configured to determine which storage queue needs to write data.

In one embodiment, when the data length is 1 and the first value is 0000000000000001, the bit having identifier 1 (i.e., first bit on the right of the first value) may correspond to storage queue 1. Therefore, the write enable bus may be configured to determine that the storage queue 1 needs to write data. When the first value is 0000000000000010, the bit having identifier 1 (i.e., second bit on the right of the first value) may correspond to storage queue 2. Therefore, the write enable bus may be configured to determine that the storage queue 2 needs to write data. In another embodiment, when the data length is 2 and the first value is 0000000000000011, the bits of identifier 1 (i.e., first and second bits on the right) may correspond to storage queue 1 and storage queue 2. Therefore, the write enable bus may be configured to determine that the storage queue 1 and storage queue 2 need to write data. When the first value is 1100000000000000, the bits of identifier 1 may correspond to the storage queue 15 and the storage queue 16. Therefore, the write enable bus may be configured to determine that the storage queue 15 and the storage queue 16 need to write data. In certain embodiments, when the data length is 16 and the first value is 1111111111111111, the bits of identifier 1 may correspond to storage queues 1-16. Therefore, the write enable bus may be configured to determine that the storage queues 1-16 need to write data.

Referring to FIG. 3, the first shifting sub-circuit may be configured to read the byte offset from the offset register, and may convert the input data (for the convenience of distinction, referred to the first input data) into the second input data (for convenience of distinction, referred to the second input data) according to the byte offset. Each sub-data included in the second input data corresponds to one bit in the first value.

For example, the second offset number L2 may be determined according to the byte offset, and each sub-data in the first input data may be cyclically left-shifted by L2 bits, to obtain the second input data.

The first input data and the second input data may be hexadecimal data, binary data, or decimal data, which may not be limited by the present disclosure. For illustrative purposes, the first input data and the second input data being hexadecimal data may be used as an example in the following.

The first input data may include an image pixel value and/or an outside-padding pixel value. The second offset number L2 may include a product of the byte offset and a specific value (such as 8). For example, suppose the specific value is 8, when cyclically left-shifting the first input data, the left most L2 bits of the first input data denoted as data having a length of N*8 bits may become the right most L2 bits.

For example, the first input data may be hexadecimal 0x3322 (or 0x00000000000000000000000000003322 if denoted as data having a length of N*8 bits), and each byte may be a sub-data. The hexadecimal 0x3322 may include two sub-data: 33, and 22. For example, the sub-data 22 may be 1 byte, and the total may be 8 bits. The sub-data 33 may be 1 byte, and the total may be 8 bits.

When the byte offset is 1, the second offset number may be 1*8 bits, i.e., 1 byte. After cyclically left-shifting 8 bits for each sub-data in the first input data 0x3322, the obtained second input data may be 0x332200. When the byte offset is 2, the second offset number may be 2*8 bits, i.e., 2 bytes. After cyclically left-shifting 16 bits for each sub-data in the first input data 0x3322, the obtained second input data may be 0x33220000. In 0x33220000, the first sub-data may be sub-data 00, the second sub-data may be sub-data 00, the third sub-data may be sub-data 22, and the fourth sub-data may be sub-data 33.

When the first value is 0000000000000001 and the second input data is 0x33220000, from the low-order bit to the high-order bit of the first value, the first sub-data 00 may correspond to a first bit of the first value (i.e., identifier 1), the second sub-data 00 may correspond to a second bit of the first value (i.e., identifier 0), the third sub-data 22 may correspond to a third bit of the first value (i.e., identifier 0), and the fourth sub-data 33 may correspond to a fourth bit of the first value (i.e., identifier 0).

After obtaining the second input data, the first shifting sub-circuit may generate a signal for the write data bus of the storage queue according to the second input data, and the write data bus may be configured to determine which data needs to be written.

In one embodiment, the sub-data corresponding to a bit whose value is the first identifier (such as 1) may be selected from the second input data, and the selected sub-data may be stored in the storage queue corresponding to the bit.

For example, when the first value is 0000000000001100 and the second input data is 0x33220000, counting from the low-order bit to high-order bit of the first value, the bit whose value is the first identifier 1 may include a third bit and a fourth bit. The third bit may correspond to the third sub-data 22, and the fourth bit may correspond to the fourth sub-data 33. The third bit may correspond to the storage queue 3, and the fourth bit may correspond to the storage queue 4. Therefore, the sub-data 22 may be written into the storage queue 3, and the sub-data 33 may be written into the storage queue 4.

In one embodiment, on an output side of the storage queue, if it is detected that the data output condition is satisfied (for example, every storage queue may store sub-data, in other words, every storage queue may be non-empty, which means that each storage queue may at least contain one valid byte), a read-enable signal may be generated to make every storage queue readable, and the sub-data in every storage queue (only one byte in each storage queue) may be simultaneously read. These pieces of sub-data simultaneously read are aligned (e.g., as N-byte data).

Based on the above technical solutions, in the disclosed embodiments of the present disclosure, the outside-padding operation (such as the zero-padding operation performed on the edge of the input feature map) may be achieved by a processing circuit, and the CPU may not need to implement the outside-padding operation. Therefore, the burden of the CPU may be reduced, the outside-padding operation may be efficiently performed, and the processing efficiency may be improved.

### Exemplary Embodiment 3

On the basis of Embodiment 2, the above data processing method may be described in detail below in conjunction with specific application scenarios. In a present application scenario, the number of the storage queues N=16 may be used as an example for description.

First: obtaining the first input data 0x11. The data length of the first input data may be 1, which may mean that the length of the first input data may be 1 byte, i.e., 8 bits. The first input data 0x11 may be an image pixel value (i.e., effective value) of the input feature map, an outside-padding pixel value (e.g., padding value 0) of the input feature map, or both the image pixel value and outside-padding pixel value of the input feature map, which is not limited by the present disclosure.

Because the data length is 1, the second value may be 0000000000000001. If the byte offset currently stored in the offset register is 0, after cyclically left-shifting 0 bit for each bit in the second value, the obtained first value may be 0000000000000001. In other words, the signal for the write enable bus for the storage queues may be 0000000000000001 (i.e., data is written to storage queue 1).

In addition, because the first input data is 0x11 and the byte offset is 0, the second offset number may be 0*8. In other words, the second offset number may be 0. After cyclically left-shifting 0 bit for each sub-data in the first input data 0x11, the obtained second input data may be 0x11. In other words, the signal for the write data bus may be 0x11 (i.e., the data being written to a storage queue is 0x11).

Then, from the low-order bit to the high-order bit of the first value 0000000000000001, the bit whose value is the first identifier 1 may be the first bit, the first bit may correspond to the first sub-data 0x11, and the first bit may correspond to the storage queue 1. Therefore, the sub-data 0x11 may be written into the storage queue 1.

In one embodiment, while or after the sub-data is written into the storage queue 1, the byte offset stored in the offset register may be adjusted to 1. In other words, the byte offset may be a sum of the currently stored byte offset 0 and the data length 1 of the current first input data.

Second: obtaining the first input data 0x3322 (e.g., 0x3322 is the next first input data of the first input data 0x11 as discussed in the example above). The data length of the first input data may be 2, which may mean that the length of the first input data may be 2 bytes, i.e., 16 bits, and the byte offset may be 1.

Because the data length is 2, the second value may be 0000000000000011. Because the byte offset is 1, after cyclically left-shifting 1 bit for each bit in the second value, the obtained first value may be 0000000000000110. In other words, the signal for the write enable bus may be 0000000000000110.

Because the first input data is 0x3322 and the byte offset is 1, the second offset number may be 1*8. In other words, the second offset number may be 8. After cyclically left-shifting 8 bits for each sub-data in the first input data 0x3322, the obtained second input data may be 0x332200. In other words, the signal for the write data bus may be 0x332200.

Then, from the low-order bit to the high-order bit of the first value 0000000000000110, the bit whose value is the first identifier 1 may be the second bit and the third bit. The second bit may correspond to the second sub-data 0x22 and the storage queue 2. The third bit may correspond to the third sub-data 0x33 and the storage queue 3. Therefore, the sub-data 0x22 may be written into the storage queue 2 and the sub-data 0x33 may be written into the storage queue 3.

In one embodiment, the byte offset stored in the offset register may be adjusted to 3. In other words, the byte offset may be a sum of the currently stored byte offset 1 and the data length 2 of the current first input data.

Third: obtaining the first input data 0xffeeddccbbaa99887766554433221100 (which is the next first input data of the first input data 0x3322 as discussed in the example above). The data length of the first input data may be 16, which may mean that the length of the first input data may be 16 bytes, and the byte offset may be 3.

Because the data length is 16, the second value may be 1111111111111111. Because the byte offset is 3, after cyclically left-shifting 3 bits for each bit in the second value, the obtained first value may be 1111111111111111. In other words, the signal at the write enable bus may be 1111111111111111.

Because the first input data is 0xffeeddccbbaa99887766554433221100 and the byte offset is 3, the second offset number may be 3*8. In other words, the second offset number may be 24. After cyclically left-shifting 24 bits for each sub-data in the first input data 0xffeeddccbbaa99887766554433221100, the obtained second input data may be 0xcebbaa99887766554433221100ffeedd. In other words, the signal at the write data bus may be 0xcebbaa99887766554433221100ffeedd.

Then, from the low-order bit to the high-order bit of the first value 1111111111111111, the bits whose value is the first identifier 1 may be the first through the sixteenth bits. The first bit may correspond to the first sub-data 0xdd and the storage queue 1, and the sub-data 0xdd may be written into the storage queue 1. The second bit may correspond to the second sub-data 0xee and the storage queue 2, and the sub-data 0xee may be written into the storage queue 2. The third bit may correspond to the third sub-data 0xff and the storage queue 3, and the sub-data 0x33 may be written into the storage queue 3, and so on. The 16th bit may correspond to the sixteenth sub-data 0xcc and storage queue 16, and the sub-data 0xcc may be written into the storage queue 16.

In one embodiment, the byte offset stored in the offset register may be adjusted to 3. In other words, the byte offset may be a sum of the currently stored byte offset 3 and the data length 16 of the current first input data. Because the sum of 3 and 16 is 19, and 19 is greater than 16, therefore, 19 may be turned into 3 (i.e. 19-16).

After performing the above process, every storage queue may be non-empty. Storage queues 1-3 may contain 2 valid bytes, and storage queues 4-16 may contain 1 valid byte. Therefore, the output condition may be satisfied, which may enable every storage queue as readable. The sub-data 0x11 may be read from storage queue 1, the sub-data 0x22 may be read from storage queue 2, the sub-data 0x33 may be read from storage queue 3, the sub-data 0x00 may be read from storage queue 4, the sub-data 0x11 may be read from storage queue 5, the sub-data 0x22 may be read from storage queue 6, and so on, the sub-data 0xcc may be read from the storage queue 16. After performing the above process, the sub-data in every storage queue may be read at the same time, and the read sub-data may achieve the alignment operation. Further, after the sub-data is read, storage queues 4-16 may become empty, storage queues 1-3 may contain 1 valid bytes, and are 0xdd, 0xee, and 0x33 respectively.

### Exemplary Embodiment 4

The present disclosure provides a data processing method. The data processing method may be configured to achieve the function of producing aligned output from input with a variable length (e.g., inside-padding operation, zero-padding operation performed on the inside of the input feature map). FIG. 4 illustrates a schematic flowchart of the data processing method. Referring to FIG. 4, the method may include following.

In step 401: acquiring a third input data, where the third input data may include an image pixel value, e.g., effective value in the input feature map, and an inside-padding pixel value, e.g., a padding value for the input feature map.

In step 402: outputting the third input data to an asymmetric storage queue, and storing the pixel value in the third input data through the plurality of sub-storage queues included in the asymmetric storage queue.

The third input data may include R image pixel values, and S inside-padding pixel values after each image pixel value. Moreover, the asymmetric storage queue may include S+1 sub-storage queues.

Storing the pixel values in the third input data through the plurality of sub-storage queues included in the asymmetric storage queue may include storing the R pixel values in the third input data through each sub-storage queue. Moreover, different sub-storage queue may be configured to store the pixel values in the third input data at a different position.

In step 403: when the data output condition is satisfied, outputting the pixel values stored in the sub-storage queues.

When detecting that every sub-storage queue stores a pixel value (in other words, every sub-storage queue is non-empty), it may be determined that the data output condition is satisfied, and the pixel values stored in the sub-storage queues may be outputted.

Outputting the pixel value stored in the sub-storage queue may include but may not be limited to: reading a pixel value from each sub-storage queue among the entire sub-storage queues, and outputting the read pixel values.

In one embodiment, reading the pixel value from each sub-storage queue among the entire sub-storage queues and outputting the read pixel value may include but may not be limited to: in accordance with the order of each sub-storage queue (in other words, the sequence of the sub-storage queues), sequentially traversing each sub-storage queue among the entire sub-storage queues, reading the R pixel values from the currently traversed sub-storage queues, and outputting the read R pixel values.

In the above embodiment, the asymmetric storage queue may include but may not be limited to an asymmetric FIFO (first-input-first-out) queue. The sub-storage queue may include but may not be limited to a sub-FIFO queue.

Based on the above technical solutions, in the disclosed embodiments of the present disclosure, the processing circuit may achieve the inside-padding operation (such as zero-padding operation performed inside the input feature map), and the CPU may not need to implement the inside-padding operation. Therefore, the burden of the CPU may be reduced, the inside-padding operation may be efficiently performed, and the processing efficiency may be improved.

### Exemplary Embodiment 5

The present disclosure provides a data processing method. The data processing method may be applied to a processing circuit to achieve the function of producing aligned output from input with a variable length (e.g., inside-padding operation, zero-padding operation performed on the inside of the input feature map) and to achieve an asymmetric storage queue structure with a variable transmission length, and may have a strong scalability.

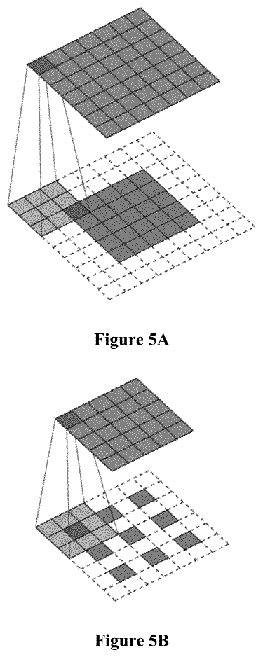

An image processing process may often involve inside-padding operation of the image. FIG. 5A illustrates a schematic diagram of an inverse convolution operation when stride is equal to 1. For example, referring to FIG. 5A, when the stride is greater than 1, the convolution kernel of the inverse convolution may become a convolution with a “hole”, i.e., a micro-step convolution. Therefore, the step size of the transposed convolution may become 1/i times of the step size of the forward convolution, and the convolution kernel may move at a substantially smaller step. Referring to FIG. 5B, when the stride is greater than 1, a plurality of zeros may need to be interpolated into the input feature map to obtain an output feature map, and the operation of interpolating the plurality of zeros are referred as the inside-padding operation. In the image processing process, if the CPU is used to accomplish the above inside-padding operation, the processing burden of the CPU may greatly increase, and the processing efficiency may be substantially low.

In the disclosed embodiments of the present disclosure, the disclosed processing circuit may achieve the function of producing aligned output from input with a variable length (e.g., inside-padding operation, zero-padding operation performed on the inside of the input feature map), and the CPU may not need to implement the inside-padding operation. Therefore, the burden of the CPU may be reduced, the inside-padding operation may be efficiently performed, and the processing efficiency may be improved.

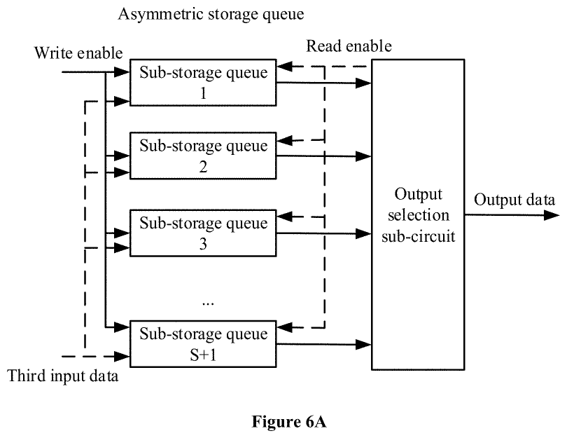

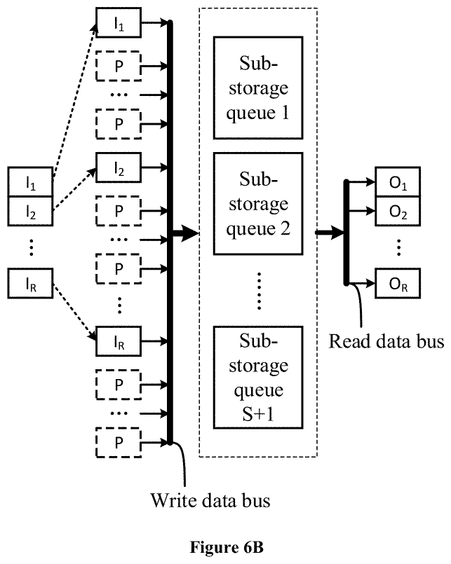

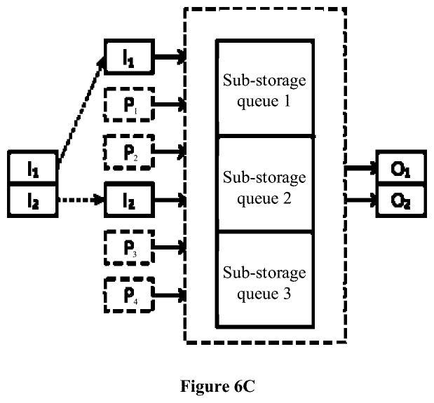

Referring to FIG. 6A, the processing circuit may include an asymmetric storage queue and an output selection sub-circuit (i.e., output data selection logic). The asymmetric storage queue may be a FIFO queue. The asymmetric storage queue may include a plurality of sub-storage queues, and each sub-storage queue may be a FIFO queue.

In one embodiment, when an original image (e.g., the input feature map not inside-padded) is aligned according to the R image pixel values as input, and S inside-padding pixel values may be padded after each image pixel value (for convenient distinction, the image pixel value may refer to pixel value I, and the inside-padding pixel value may refer to pixel value P), the input data of the asymmetric storage queue may be the third input data. The third input data may include R image pixel values I, and S inside-padding pixel values P padded after each image pixel value.

Referring to FIG. 6B, S inside-padding pixel values P may be padded after each image pixel value I to form a signal on a write data bus with a width of R*(S+1) as input data (i.e., the third input data) of the asymmetric storage queue (asym_fifo). The third input data may include R image pixel values I, and S inside-padding pixel values P padded after each image pixel value. In addition, the asymmetric storage queue may output a signal for a read data bus with a width of R, thereby automatically achieving the aligned output of the inside-padding. The asymmetric storage queue may include S+1 sub-storage queues, thereby achieving the data bit width conversion from input bit width R*(S+1) to output bit width R.

In one embodiment, when the bit width of the input data (i.e., the third input data) of the asymmetric storage queue is R*(S+1), and the bit width of the output data of the asymmetric storage queue is R, the asymmetric storage queue may include S+1 sub-storage queues with bit width of R and a depth of M. A same write enable signal is used at the input side of each sub-storage queue. Once the third input data is valid, the write enable of every sub-storage queue may be activated, and each sub-storage queue may store R bits of the third input data in sequence. In other words, each sub-storage queue may store R pixel values in the third input data, and different sub-storage queue may be configured to store the pixel value of the third input data at different position. Therefore, the storage is not be repeated.

For example, from a lowest-order bit to a highest-order bit of the third input data, a sub-storage queue 1 may store first R bits (lowest R bits) of the third input data, a sub-storage queue 2 may store second R bits of the third input data, and so on, a sub-storage queue S+1 may store S+1th R bits (the highest R bits) of the third input data. It may ensure that the write operation of R*(S+1) bit data may be achieved in one clock cycle. For example, when R is 4 and S is 2, sub-storage queue 1 may store pixel values of I1, P1, P2, I2, sub-storage queue 2 may store pixel values of P3, P4, I3, P5, and sub-storage queue 3 may store pixel values of P6, I4, P7, P8.

Referring to FIG. 6A and FIG. 6B, for an output side of each sub-storage queue, independent read enable signal of each output line may be used. Once detecting that the data output condition is satisfied (e.g., every sub-storage queue is non-empty and the output is not blocked), the output selection sub-circuit may sequentially activate each sub-storage queue one time in sequence, and may use the output data of the currently activated sub-storage queue as the output data of the asymmetric storage queue.

Accordingly, in accordance with the order of each sub-storage queue, each sub-storage queue may be sequentially traversed, the R pixel values may be read from the currently traversed sub-storage queue, and the read R pixel values may be outputted.

After sequentially traversing the entire sub-storage queues one time, in other words, after reading the R pixel values from each sub-storage queue of the entire sub-storage queues, a read operation of the asymmetric storage queue may be achieved. Therefore, the pixel value in each sub-storage queue may be outputted, in other words, the pixel value in the asymmetric storage queue may be outputted.

Based on the above technical solutions, in the disclosed embodiments of the present disclosure, the processing circuit may achieve the inside-padding operation (e.g., zero-padding operation performed on the inside of the input feature map), and the CPU may not need to implement the inside-padding operation. Therefore, the burden of the CPU may be reduced, the inside-padding operation may be efficiently performed, and the processing efficiency may be improved.

### Exemplary Embodiment 6

On the basis of Embodiment 5, the above data processing method may be described below in combination with a specific application scenario. In an application scenario, referring to FIG. 6C, R=2 and S=2 may be used as an example for description. The asymmetric storage queue may include 3 (i.e., S+1) sub-storage queues. The two image pixel values included in the third input data may include a pixel value I1 and a pixel value I2, respectively. The two inside-padding pixel values after the pixel value I1 may include a pixel value P1 and a pixel value P2, respectively. The two inside-padding pixel values after the pixel value I2 may include a pixel value P3 and a pixel value P4, respectively. Referring to FIG. 6C, O may represent the pixel value after performing the inside-padding operation. Further, the bit widths of the above-mentioned image pixel value, inside-padding pixel value, and inside-padded pixel value may be 8 bits, respectively.

The third input data may be aligned according to two pixel values, and one inside-padding operation may correspond to two consecutive pixel values, namely the pixel value I1 and the pixel value I2. After performing the inside-padding operation, the third input data may include the pixel value I1 the pixel value P1, the pixel value P2, the pixel value I2, the pixel value P3, and the pixel value P4. Then, the pixel value I1, the pixel value P1, the pixel value P2, the pixel value I2, the pixel value P3, and the pixel value P4 may be inputted into the asymmetric storage queue. The pixel value I1 and the pixel value P1 may be written into the sub-storage queue 1, the pixel value P2 and the pixel value I2 may be written into the sub-storage queue 2, and the pixel value P3 and the pixel value P4 may be written into the sub-storage queue 3.

Then, once detecting that the data output condition is satisfied, the output selection sub-circuit may first activate the sub-storage queue 1 to read out the pixel value I1 and the pixel value P1, then may activate the sub-storage queue 2 to read out the pixel value P2 and the pixel value I2, and then may activate the sub-storage queue 3 to read out the pixel value P3 and the pixel value P4. Therefore, after 3 clock cycles, the inside-padded data may align output according to 2 pixel values.

Furthermore, by repeating the above operations, the inner-padded entire image may be outputted in rows.

### Exemplary Embodiment 7

On the basis of Embodiments 4-6, the third input data may be obtained, and may be outputted to the asymmetric storage queue. The pixel values in the third input data may be stored through the plurality of sub-storage queues included in the asymmetric storage queue. When the data output condition is satisfied, the pixel value stored in the sub-storage queue may be outputted. Further, the outputted pixel value may be the original data of the input feature map, and the pixel value of the input feature map may be the image pixel value of the input feature map. The image pixel value may be regarded as the first input data. Alternatively, after performing the outside-padding operation on the input feature map, the image pixel value and the outside-padding pixel value may be regarded as the first input data. Alternatively, after performing the outside-padding operation on the input feature map, the outside-padding pixel value may be regarded as the first input data, which may not be limited by the present disclosure. Then, the first input data may be used as the input data in Embodiments 1-3, which may not be limited by the present disclosure.

### Exemplary Embodiment 8

The present disclosure also provides a processing circuit. The processing circuit may include a selection sub-circuit for obtaining the first value according to the byte offset and the data length of the first input data. The first value may include N bits, the value of each bit may be one of the first identifier and the second identifier, and each bit may correspond to one storage queue. The processing circuit may also include a first shifting sub-circuit configured to obtain the second input data according to the byte offset and the first input data. Each sub-data included in the second input data may correspond to one bit in the first value. In addition, the processing circuit may include at least N storage queues, configured to store the sub-data included in the second input data and corresponding to the bit whose value is the first identifier into a storage queue corresponding to the bit in the first value whose value is the first identifier. When the data output condition is satisfied, the sub-data stored in the storage queues may be outputted. The first input data may include an image pixel value and/or an outside-padding pixel value.

In one embodiment, the selection sub-circuit may include a byte enable sub-circuit for converting the data length of the first input data into a second value having N bits. The value of each bit may be one of the first identifier and the second identifier. In addition, the selection sub-circuit may include a second shifting sub-circuit configured to offset the second value according to the byte offset to obtain the first value.

When converting the data length of the first input data into the second value having N bits, the byte enable sub-circuit may be configured to: based on the data length M, set the last M bits of the second value as the first identifier, and set the first N−M bits of the second value as the second identifier, where M may be less than or equal to N.

When offsetting the second value according to the byte offset to obtain the first value, the second shifting sub-circuit may be configured to: determine the first offset number L1 according to the byte offset, and cyclically left-shift L1 bits for each bit in the second value to obtain the first value. The first offset number may include the byte offset.

When obtaining the second input data according to the byte offset and the first input data, the first shifting sub-circuit may be configured to: determine a second offset number L2 according to the byte offset, and cyclically left-shift L2 bits for each sub-data in the first input data to obtain the second input data. The second offset number may include a product of the byte offset and a specific value.

The processing circuit may further include an offset register, configured to record a byte offset, where the byte offset may be less than or equal to N. The offset register may be configured to output the recorded byte offset to the selection sub-circuit and the first shifting sub-circuit.

After the first shifting sub-circuit obtains the second input data according to the byte offset and the first input data, the offset register may be configured to accumulate the byte offset in the offset register with the data length to obtain a new byte offset (that is, add the data length to the byte offset to obtain the new byte offset). The obtained new byte offset may be updated to the offset register.

In one embodiment, if every storage queue stores a sub-data, it may be determined that the data output condition is satisfied. Further, when outputting the sub-data stored in the storage queue, the sub-data may be read from each storage queue among entire storage queues, and the read sub-data may be outputted.

### Exemplary Embodiment 9

The present disclosure also provides a processing circuit. The processing circuit may include an asymmetric storage queue for receiving the third input data. The third input data may include the image pixel value and the inside-padding pixel value. The pixel values in the third input data may be stored through a plurality of sub-storage queues included in the asymmetric storage queue. The processing circuit may also include an output selection sub-circuit. When the data output condition is satisfied, the output selection sub-circuit may read the pixel value stored in the sub-storage queue and output the pixel value stored in the sub-storage queue.

The third input data may include R image pixel values and S inside-padding pixel values after each image pixel value. The asymmetric storage queue may include S+1 sub-storage queues.

When storing the pixel values in the third input data through the plurality of sub-storage queues, the asymmetric storage queue may be configured to store R pixel values in the third input data through each sub-storage queue, and a different sub-storage queue may be configured to store the pixel value in the third input data at a different position.

In one embodiment, the output selection sub-circuit may be further configured to when detecting that every sub-storage queue has a stored pixel value, determine that the data output condition is satisfied. When reading the pixel value stored in the sub-storage queue and outputting the pixel value stored in the sub-storage queue, the output selection sub-circuit may be configured to read the pixel value from each sub-storage queue among the entire sub-storage queues, and may output the read pixel value.

In one embodiment, when reading the pixel value from each sub-storage queue of the entire sub-storage queues and outputting the read pixel value, the output selection sub-circuit may be configured to: in accordance with the order of each sub-storage queue, sequentially traverse each sub-storage queue of the entire sub-storage queues, read the R pixel values from the currently traversed sub-storage queue, and output the read R pixel values.

The system, device, module or unit in the above-disclosed embodiments may be implemented by a computer chip or an entity, or may be implemented by a product with a certain function. A typical implementation device may be a computer. The computer may be a personal computer, a laptop computer, a cellular phone, a camera phone, a smart phone, a personal digital assistant, a media player, a navigation device, an email receiving and sending device, a game control console, a tablet computer, a wearable device, or a combination thereof.

For the convenience of description, when describing the above device, various units may be divided according to functions and described separately. When implementing the present disclosure, the functions of each unit may be implemented in the same one or more software and/or hardware.

Those skilled in the art may understand that the disclosed embodiments of the present disclosure may provide method, system, or computer program product. Therefore, the present disclosure may adopt the form of a full hardware embodiment, a full software embodiment, or an embodiment combining software and hardware. Moreover, the disclosed embodiments of the present disclosure may adopt the form of computer program products implemented on one or more computer-usable storage media (including but not limited to a disk storage, a CD-ROM, an optical storage, etc.) containing computer-usable program codes.

The present disclosure is described with reference to a flowchart and/or a block diagram of method, device (system), and computer program product according to embodiments of the present disclosure. It should be understood that each process and/or block in the flowchart and/or block diagram, and the combination of processes and/or blocks in the flowchart and/or block diagram may be implemented by a computer program instruction. Such computer program instructions may be provided to the processor of a general-purpose computer, a special-purpose computer, an embedded processor, or any other programmable data processing device to generate a machine, such that the instruction executed by the processor of the computer or any other programmable data processing device may be used in an equipment that achieves the functions specified in one process or multiple processes in the flowchart and/or one block or multiple blocks in the block diagram.

Moreover, such computer program instructions may be stored in a computer-readable memory that is capable of guiding a computer or any other programmable data processing device to work in a specific manner. Therefore, the instructions stored in the computer-readable memory may produce a product including an instruction device, and the instruction device may implement the functions specified in one process or multiple processes in the flowchart and/or one block or multiple blocks in the block diagram.

Such computer program instructions may be loaded into a computer or any other programmable data processing device, such that a series of operation steps may be executed on the computer or any other programmable device to produce computer-implemented processing. The instructions executed on the computer or any other programmable device may provide steps for realizing the functions specified in one process or multiple processes in the flowchart and/or one block or multiple blocks in the block diagram.

The above detailed descriptions only illustrate certain exemplary embodiments of the present disclosure, and are not intended to limit the scope of the present disclosure. Those skilled in the art can understand the specification as whole and technical features in the various embodiments can be combined into other embodiments understandable to those persons of ordinary skill in the art. Any equivalent or modification thereof, without departing from the spirit and principle of the present disclosure, falls within the true scope of the present disclosure.

What is claimed is:

1. A data processing method, comprising:
obtaining a first input data and a data length of the first input data;
obtaining a first value according to a byte offset and the data length of the first input data, wherein the first value includes N bits, a value of each bit of the first value is one of a first identifier and a second identifier, and each bit corresponds to one storage queue;
obtaining a second input data according to the byte offset and the first input data, wherein each sub-data included in the second input data corresponds to one bit in the first value;
selecting the sub-data corresponding to a bit whose value is the first identifier from the second input data, and storing the selected sub-data in the storage queue corresponding to the bit whose value is the first identifier; and
when a data output condition is satisfied, outputting the sub-data stored in the storage queue.

2. The method according to claim 2, wherein:
the first input data includes one or more of an image pixel value or an outside-padding pixel value.

3. The method according to claim 1, wherein: obtaining the first value according to the byte offset and the data length of the first input data comprises:
converting the data length of the first input data to a second value having N bits, a value of each bit of the second value being one of the first identifier and the second identifier, including:
based on the data length M, set last M bits of the second value as the first identifier, and set first (N−M) bits of the second value as the second identifier, M being less than or equal to N; and
offsetting the second value according to the byte offset to obtain the first value.

4. The method according to claim 3, wherein offsetting the second value according to the byte offset to obtain the first value comprises:
determine a first offset number L1 according to the byte offset, and cyclically left-shift L1 bits for each bit in the second value to obtain the first value.

5. The method according to claim 1, wherein obtaining the second input data according to the byte offset and the first input data comprises:
determine a second offset number L2 according to the byte offset, and cyclically left-shift L2 bits for each sub-data in the first input data to obtain the second input data.

6. The method according to claim 1, further comprising:
before obtaining the first value according to the byte offset and the data length of the first input data, reading the byte offset from an offset register, wherein the offset register is configured to record the byte offset, and the byte offset recorded by the offset register is less than or equal to N; and
after obtaining the second input data according to the byte offset and the first input data, accumulating the byte offset in the offset register with the data length of the first input data to obtain a new byte offset, and updating the obtained new byte offset in the offset register.

7. The method according to claim 1, wherein:
the data output condition is satisfied upon determining that every storage queue stores a sub-data.

8. The method according to claim 1, further comprising: before obtaining the first input data and the data length of the first input data,
obtaining third input data that includes pixel values, the pixel values including an image pixel value and an inside-padding pixel value; and
outputting the third input data to an asymmetric storage queue, and storing the pixel values in the third input data to a plurality of sub-storage queues included in the asymmetric storage queue;
outputting the pixel values stored in the sub-storage queues when a data output condition corresponding to the third data is satisfied; and
obtaining an image pixel value of the first input data according to the outputted pixel values; and
obtaining the first input data according to at least one of the image pixel value of the first input data or an outside-padding pixel value of the first input data.

9. The method according to claim 8, wherein:
the third input data includes R image pixel values, and S inside-padding pixel values after each of the R image pixel values; and
the asymmetric storage queue includes S+1 sub-storage queues, each sub-storage queue being configured to store R pixel values of the third input data.

10. The method according to claim 8, wherein:
the data output condition corresponding to the third data is satisfied upon determining that all sub-storage queues have stored pixel values.

11. The method according to claim 8, wherein outputting the pixel values stored in the sub-storage queues comprises:
sequentially traversing each of the sub-storage queues according to a sequence of the sub-storage queues;
reading R pixel values from a currently traversed sub-storage queue; and
outputting the R pixel values read from the currently traversed sub-storage queue.

12. A processing circuit, comprising:
a selection sub-circuit, configured to obtain a first value according to a byte offset and a data length of a first input data, wherein the first value includes N bits, a value of each bit of the first value is one of a first identifier and a second identifier, and each bit corresponds to one storage queue;
a first shifting sub-circuit, configured to obtain a second input data according to the byte offset and the first input data, wherein each sub-data included in the second input data corresponds to one bit in the first value; and
at least N storage queues, each configured to store the sub-data according a value of the bit corresponding to the storage queue, wherein the sub-data corresponding to a bit whose value is the first identifier is stored into a storage queue corresponding to the bit, wherein:
when a data output condition is satisfied, the sub-data stored in the at least N storage queues is outputted.

13. The processing circuit according to claim 12, wherein:
the first input data includes one or more of an image pixel value or an outside-padding pixel value.

14. The processing circuit according to claim 12, wherein the selection sub-circuit includes:
a byte enable sub-circuit, configured to convert the data length of the first input data to a second value having N bits, wherein a value of each bit of the second value is one of the first identifier and the second identifier; and
a second shifting sub-circuit, configured to offset the second value according to the byte offset to obtain the first value.

15. The processing circuit according to claim 14, wherein when converting the data length of the first input data into the second value having N bits, the byte enable sub-circuit is configured to:
based on a data length M, set last M bits of the second value as the first identifier, and set first (N−M) bits of the second value as the second identifier, wherein M is less than or equal to N.

16. The processing circuit according to claim 14, wherein when offsetting the second value according to the byte offset to obtain the first value, the second shifting sub-circuit is configured to:
determine a first offset number L1 according to the byte offset, and cyclically left-shift L1 bits for each bit in the second value to obtain the first value, wherein the first offset number includes the byte offset.

17. The processing circuit according to claim 12, wherein when obtaining the second input data according to the byte offset and the first input data, the first shifting sub-circuit is configured to:
determine a second offset number L2 according to the byte offset, and cyclically left-shift L2 bits for each sub-data in the first input data to obtain the second input data, wherein the second offset number includes a product of the byte offset and a specific value.

18. The processing circuit according to claim 12, further including:
an offset register, configured to record the byte offset, and output the recorded byte offset to the selection sub-circuit and the first shifting sub-circuit, wherein the byte offset is less than or equal to N.

19. The processing circuit according to claim 18, wherein the offset register is further configured to:
after the first shifting sub-circuit obtains the second input data according to the byte offset and the first input data, accumulate the byte offset in the offset register with the data length of the first input data to obtain a new byte offset, and update the obtained new byte offset in the offset register.

20. The processing circuit according to claim 12, wherein:
when every storage queue stores a sub-data, the data output condition is satisfied; and
when outputting the sub-data stored in the storage queues, the sub-data is read from each storage queue among entire storage queues, and the read sub-data is outputted.
